(19) United States
(12) Patent Application Publication
(10) Pub. No.: US 2014/0017362 A1
(43) Pub. Date: Jan. 16, 2014

(54) METHOD FOR PRODUCING CONFECTIONERY PRODUCTS, AND CONFECTIONERY PRODUCTS

(71) Applicants: Andreas Nevian, Saarwellingen (DE); Markus Johann Ney, Schwalbach Elm (DE)

(72) Inventors: Andreas Nevian, Saarwellingen (DE); Markus Johann Ney, Schwalbach Elm (DE)

(73) Assignee: LUDWIG SCHOKOLADE GMBH & CO. KG, Bergisch Gladbach (DE)

(21) Appl. No.: 13/977,890

(22) PCT Filed: Jan. 4, 2012
(86) PCT No.: PCT/EP2012/050086

§ 371 Date: Sep. 26, 2013

(30) Foreign Application Priority Data
Jan. 7, 2011 (EP) 11150369.4
Aug. 7, 2011 (EP) 11176767.9

(51) Int. Cl. A23G 1/00; A23G 1/54

(52) U.S. Cl. CPC A23G 1/0006; A23G 1/54
USPC 426/103; 426/241

(57) ABSTRACT

The invention relates to a process for producing confectionery products, which includes production of a base composition of a sugar component with one or a plurality of sugar-containing constituents, wherein the sugar content of at least one sugar-containing constituent is more than 50 wt.-%, a protein component with one or a plurality of protein-containing constituents, wherein the protein content of at least one protein-containing constituent is more than 50 wt.-%, a fat component with one or a plurality of fat-containing constituents, wherein the fat content of at least one fat-containing constituent is more than 60 wt.-%, and a flavor additive with at least one flavoring constituent; forming of core bodies from the base composition; microwave vacuum drying of the core bodies; coating of the core bodies with at least one coating layer, in particular chocolate, which is suitable for inhibiting absorption of moisture by the core bodies.

### PRIORITY CLAIM

This application is a National Stage entry under 35 U.S.C. 371 of International Application No. PCT/EP2012/050086 which claims priority to European Application No. 11150369.4 filed Jan. 7, 2011 and European Application No. 11176767.9 filed Aug. 7, 2011.

### BACKGROUND

1. Field of the Invention

The present invention is in the field of production of foodstuffs and relates to a process for producing confectionery products. It further extends to confectionery products.

2. Description of the Related Art

For the industrial production of foodstuffs with extended shelf life, a wide variety of drying techniques are used. Besides air drying (dehydration), in which water is removed from the foodstuffs in special drying apparatuses, freeze-drying, which enables gentle handling of, for example, fruits and coffee, is often used. In freeze-drying, the foodstuffs are cooled to very low temperatures of, for example, −70° C., and the frozen water is subsequently removed by sublimation in an evacuated environment. Although, in freeze-drying, essential oils are retained as flavor carriers, the foodstuffs change shape, volume, and color relatively markedly. Recently, microwave vacuum drying has been increasingly used with vegetables, fruits, meat and fish products. In this method, the foodstuffs are evacuated in special microwave vacuum drying vessels and irradiated with microwaves, with the shape and color of the foodstuffs largely retained. In the patent literature, microwave vacuum drying has been described, for example, in the German patent application DE P4036112.8. Microwave vacuum drying vessels are currently marketed by a number of companies.

### SUMMARY

Methods for producing confectionery products are described herein. In some embodiments, a method for producing confectionery products, which includes the following successive steps:
production of a base composition of a sugar component with one or a plurality of sugar-containing constituents, wherein the sugar content of at least one sugar-containing constituent is more than 50 wt.-%, a protein component with one or a plurality of protein-containing constituents, wherein the protein content of at least one protein-containing constituent is more than 50 wt.-%, a fat component with one or a plurality of fat-containing constituents, wherein the fat content of at least one fat-containing constituent is more than 60 wt.-%, and a flavor additive with at least one flavoring constituent;
forming of core bodies from the base composition;
microwave vacuum drying of the core bodies;
coating of the core bodies with at least one coating layer, in particular chocolate, which is suitable for inhibiting absorption of moisture by the core bodies.

In some embodiments, a confectionery product includes a core body puffed by microwave vacuum drying, which is produced from a base composition, containing a sugar component with one or a plurality of sugar-containing constituents, wherein the sugar content of at least one sugar-containing constituent is more than 50 wt.-%, a protein component with one or a plurality of protein-containing constituents, wherein the protein content of at least one protein-containing constituent is more than 50 wt.-%, a fat component with one or a plurality of fat-containing constituents, wherein the fat content of at least one fat-containing constituent is more than 60 wt.-%, and a flavor additive with at least one flavoring constituent; and at least one coating layer, in particular chocolate, coating the core body, which coating layer is suitable for inhibiting absorption of moisture by the core bodies.

### BRIEF DESCRIPTION OF THE DRAWINGS

FIG. 1 depicts a a flow diagram of an embodiment of producing confectionery products.

### DETAILED DESCRIPTION

The object of the present invention consists in reporting a process for producing confectionery products with extended shelf life and special organoleptic and taste properties. These and other objects are accomplished according to the proposal of the invention by means of a process for producing confectionery products with the characteristics of the independent claim. Advantageous embodiments of the invention are reported through the characteristics of the dependent claims.

In the context of the present invention, the term “component” refers to an ingredient for producing the base composition. Each component can consist of a single constituent or be produced from a plurality of constituents. Thus, a constituent serves as an element for producing a component, with, in the case that a component consists of a single constituent, this constituent being identical to the component. On the other hand, each constituent consists of one or a plurality of ingredients. Ingredients in a constituent can be added or already contained in the constituent. Data relative to percentage shares by weight refer to one or a plurality of ingredients of one and the same constituent, based in each case on the total weight of all ingredients of this constituent.

In accordance with the invention, a process for producing confectionery products is presented. The method includes the successive steps described in the following:

Production of a base composition of a sugar component, a protein component, a fat component, as well as a flavor additive that contains at least one flavoring constituent. In particular, the protein component can be a protein solution; the sugar component, a sugar solution; the fat component, a fat mixture.

The sugar component consists of one or a plurality of constituents, with it containing one or a plurality of sugar-containing constituents. For example, the sugar component is produced from a plurality of constituents, with the constituents added in each case as an element. The sugar component can, for example, even contain one or a plurality of non-sugar-containing constituents. A sugar-containing constituent contains one or a plurality of ingredients, with at least one ingredient being a sugar. In particular, a sugar-containing constituent can contain a plurality of ingredients consisting of different sugars. A sugar-containing constituent can, in particular, even contain ingredients not consisting of sugar.

The sugar component contains one or a plurality of sugar-containing constituents, with the sugar content of at least one sugar-containing constituent being more than 50 wt.-% (percent by weight), in particular more than 80 wt.-%. When the sugar component contains only one single sugar-containing constituent, the sugar content of this sugar-containing constituent is more than 50 wt.-%, in particular more than 80 wt.-%. When the sugar component contains a plurality of sugar-containing constituents, the sugar content of one or a plurality, for example, of all, sugar containing constituents is in each case more than 50 wt.-%, in particular more than 80 wt.-%. When the sugar component contains only one single constituent, the sugar content of the sugar-containing constituent is identical to the sugar content of the sugar component.

In the context of the present invention, the term “sugar” also includes sweetening sugar substitutes, for example, sorbitol.

The protein component consists of one or a plurality of constituents, with it containing one or a plurality of protein-containing constituents. For example, the protein component is produced from a plurality of constituents, with the constituents added in each case as an element. The protein component can, for example, even contain one or a plurality of non-protein-containing constituents. A protein-containing constituent contains one or a plurality of ingredients, with at least one ingredient being a protein. In particular, a protein-containing constituent can contain a plurality of ingredients consisting of different proteins. A protein-containing constituent can, in particular, even contain ingredients not consisting of protein.

The protein component contains one or a plurality of protein-containing constituents, with the protein content of at least one protein-containing constituent being more than 50 wt.-%, in particular, more than 80 wt.-%. When the protein component contains only one single protein-containing constituent, the protein content of this protein-containing constituent is more than 50 wt.-%, in particular, more than 80 wt.-%. When the protein component contains a plurality of protein-containing constituents, the protein content of one or a plurality, for example, of all, protein-containing constituents is in each case more than 50 wt.-%, in particular, more than 80 wt.-%. When the protein component contains only one single constituent, the protein content of the protein-containing constituent is identical to the protein content of the protein component.

As a protein-containing constituent, gelatine, in particular, can be used. In the case of the protein-containing constituent, which has a protein content of more than 50 wt.-%, this is not a powder that largely (based on weight shares) contains no protein-containing ingredients. The same applies if the protein component has only one single protein-containing constituent.

The fat component consists of one or a plurality of constituents, with it containing one or a plurality of fat-containing constituents. For example, the fat component is produced from a plurality of constituents, with the constituents added in each case as an element. The fat component can, for example, even contain one or a plurality of non-fat-containing constituents. A fat-containing constituent contains one or a plurality of ingredients, with at least one ingredient being a fat. In particular, a fat-containing constituent can contain a plurality of ingredients consisting of different fats. A fat-containing constituent can, in particular, even contain ingredients not consisting of fat.

The fat component contains one or a plurality of fat-containing constituents, with the fat content of at least one fat-containing constituent being more than 60 wt.-%, in particular, more than 95 wt.-%. When the fat component contains only one single fat-containing constituent, the fat content of this fat-containing constituent is more than 60 wt.-%, in particular, more than 95 wt.-%. When the fat component contains a plurality of fat-containing constituents, the fat content of one or a plurality, for example, of all, fat-containing constituents is in each case more than 60 wt.-%, in particular, more than 95 wt.-%. When the fat component contains only one single constituent, the fat content of the fat-containing constituent is identical to the fat content of the fat component.

In an advantageous embodiment of the method, during production of the base composition, the sugar component is first heated. Advantageously, the sugar component is heated in a temperature range from 120-130° C., for example, 125° C., in particular with a dry composition of ca. 92 wt.-%. Then, the sugar component is cooled under vacuum drying, with the sugar composition being cooled preferably to a temperature of 110° C. Then, the protein component is added to the sugar component, by which means a sugar/protein composition is obtained. The sugar/protein composition is then aerated, which is advantageously carried out under a high pressure of ca. 3 bar for a period of, for example, 3 min. Then, the fat component is added to the aerated sugar/protein composition and homogeneously distributed therein, by which means a fat/sugar/protein composition is obtained. Lastly, for the final completion of the base composition, the flavor additive is added to the fat/sugar/protein composition. Alternatively, the flavor additive can be optionally added to each individual component and/or to a plurality of components of the base composition and/or to the sugar/protein composition.

Forming of core bodies (centers) from the base composition. In an advantageous embodiment, for the forming of the core bodies, a sheet of the base composition, i.e., a continuous layer of the base composition, is first produced. The core bodies are stamped into the sheet of the base composition, in particular with a nodular shape and then separated from the remaining sheet of the base composition. The stamping of the core bodies into the sheet of the base composition occurs advantageously in a temperature range from 30° C.-70° C. In addition, it can be advantageous for the core bodies to be separated from the remaining sheet of the base composition at a base composition sheet temperature of, for example, ca. 10° C. Next, selection of the core bodies takes place based on a predefinable core body size, such that the core bodies obtained have a uniform, at least approx. equal size. Here, and in the following, the term “size” means a specified (selectable) dimension of the core bodies. In the case of nodular core bodies, the size is calculated from the diameter of the core bodies. In the case of non-nodular core bodies, a specific dimension of the core bodies can be freely defined for this purpose.

Performance of microwave vacuum drying (microwave puffing) of the core bodies with at least approx. equal size in a microwave vacuum drying vessel. The microwave vacuum drying vessel is implemented such that a freely adjustable vacuum is generated under freely adjustable temperatures and the core bodies can be irradiated with a freely adjustable power. Advantageously, the core bodies have, during microwave vacuum drying in the microwave vacuum drying vessel, a maximum fill height of ca. 10 cm.

In a particularly advantageous embodiment of the method according to the invention, at the time of the microwave vacuum drying of the core bodies, a vacuum of, for example, ca. 30 mbar, is first created with simultaneous movement of the core bodies. The moving of the core bodies can be accomplished, for example, by moving the microwave vacuum drying vessel, with it possibly advantageous for the microwave vacuum drying vessel to be moved in particular at a speed of ca. 5 m/min. In addition, it can be advantageous for the microwave vacuum drying vessel to be temperature controlled, in particular during filling of the core bodies such that the core bodies have, at the time of filling into the microwave vacuum drying vessel, a temperature that is, for example, in the range from 12° C.-14° C. When the desired vacuum has been set in the microwave vacuum drying vessel, the core bodies are progressively irradiated with microwave radiation at this vacuum. Advantageously, the core bodies are first irradiated with power in the range from 6-8 kW, in particular at 7 kW, for a period in the range from 80-100 s, in particular 90 s, and then irradiated with power in the range from 8-10 kW, in particular at 9 kW, for a period in the range from 170-190 s, in particular 180 s. Then, a vacuum of, for example, ca. 45 mbar is set in the microwave vacuum drying vessel, and the core bodies are irradiated at this vacuum with power in the range from 5-7 kW, in particular at 6 kW, for a period in the range from 260-280 s, in particular 270 s. Particularly advantageously, the microwave radiation power at the time of microwave puffing is selected such that, during microwave puffing, the core bodies do not exceed a maximum temperature in the range from 75-80° C., in particular 80° C.

Coating the puffed core bodies with at least one coating layer, in particular, chocolate, which is suitable for inhibiting absorption of moisture by the core bodies. In the context of the present invention, the term “coating” extends to the possibilities known per se to the person skilled in the art for applying a coating layer to the core bodies. The term includes, in particular, the application of the coating layer by dipping in or spraying with a coating material forming the coating layer as well as to glazing the core bodies, for example, in a drum. In a particularly advantageous embodiment, the core bodies are first coated with a first coating layer, in particular, chocolate, and then coated with a second coating layer over the first coating layer. The second coating layer can, in particular, be a glossy or polish layer. Advantageously, the core bodies are glazed, for example, with shellac as a second coating layer, which advantageously takes place in a drum.

Furthermore, it can be advantageous for the core bodies to be coated in each case with at least one coating layer, in particular, a first coating layer, such that the core body has a weight share, based on the coated core body, in the range from 24-26 wt.-%, in particular 25 wt.-%.

By means of the method according to the invention, novel confectionery products that have extended shelf life under normal environmental conditions due to clearly reduced hygroscopic properties can be produced advantageously. The confectionery products are distinguished by special organoleptic and flavor characteristics, with the capability of retaining or even enhancing the flavor or the aroma of the constituents included by means of the production method. The core bodies receive, by means of the microwave puffing, a porous texture that results in a light, airy taste sensation with a crunchy bite.

In a particularly advantageous embodiment of the method according to the invention, during the production of the base composition, roasted peanuts are added as a flavor additive to the fat/sugar/protein composition.

The invention further extends to a confectionery product that is produced by means of a method as described above.

In addition, the invention extends to a confectionery product that includes a core body puffed by microwave vacuum drying that is produced from a base composition, containing a sugar component with one or a plurality of sugar-containing constituents, wherein the sugar content of at least one sugar-containing constituent is more than 50 wt.-%, a protein component with one or a plurality of protein-containing constituents, wherein the protein content of at least one protein-containing constituent is more than 50 wt.-%, a fat component with one or a plurality of fat-containing constituents, wherein the fat content of at least one fat-containing constituent is more than 60 wt.-%, as well as a flavor additive with at least one flavoring constituent. Also, the confectionery product includes at least one coating layer coating the core body, in particular chocolate, which is suitable for inhibiting absorption of moisture by the core bodies. Particularly advantageously, the core body is coated with a first coating layer, in particular chocolate, and with a second coating layer over the first coating layer, in particular glazed with shellac, by which means the property of the coating material to inhibit water absorption by the core bodies is further improved and the shelf life of the confectionery product can be extended.

### Exemplary Embodiment

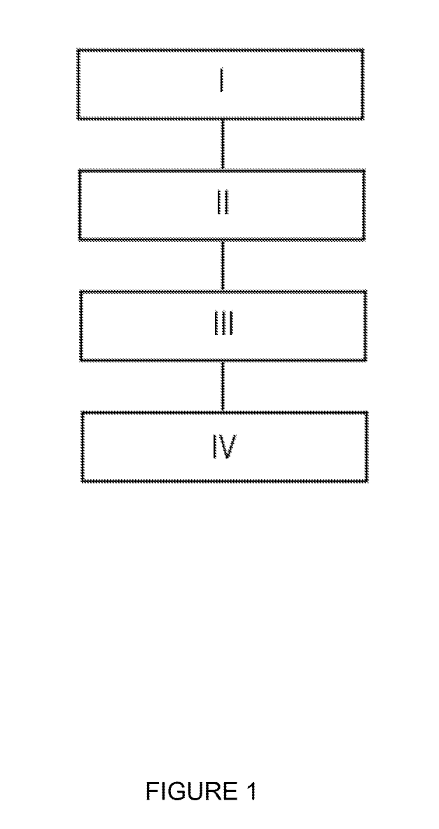

The invention is now explained in detail using an exemplary embodiment and referring to FIG. 1.

The single FIGURE schematically illustrates the performance of the method according to the invention in the form of a flow diagram.

Step I: Production of a base composition for the forming of the core bodies or centers. The base composition for the core bodies is produced from various components. It includes a sugar solution, a fat mixture, and a protein solution, with the sugar solution making up ca. 76 wt.-%; the fat mixture, ca. 16 wt.-%; and the protein solution, ca. 8 wt.-% of the base composition. The sugar solution contains one or a plurality of sugar-containing constituents, for example, selected from sucrose, glucose syrup, lactose, sorbitol syrup, barley malt extract, and caramelized sugar syrup, wherein the sugar content of at least one sugar-containing constituent is more than 50 wt.-%, in particular more than 80 wt.-%. For example, but not absolutely necessarily, the sugar content in the sugar solution is more than 50 wt.-%.

The protein solution contains one or a plurality of protein-containing constituents, for example, powdered egg white. Instead of the powdered egg white, gelatine can, for example, also be used. At least one protein-containing constituent has a protein content of more than 50 wt.-%, in particular more than 80 wt.-%.

The fat mixture contains one or a plurality of fat-containing constituents, for example, selected from whole milk powder, sweetened condensed skim milk, cream powder, cocoa butter, cocoa paste, and vegetable fats. At least one fat-containing constituent has a fat content of more than 60 wt.-%, in particular more than 95 wt.-%. In addition, various additives or flavor additives can be added, for example, roasted peanuts, to produce, as desired, flavor variants in the finished confectionery product.

For the production of the base composition, the sugar solution is heated to ca. 125° C., for example, in a continuous cooking system. The dry substance is ca. 92 wt.-%. After that, the sugar paste obtained is cooled, for example, by evacuation, preferably to a temperature of ca. 110° C., and dried at the same time. Then, the protein solution is added to the sugar paste obtained and the sugar/protein composition thus obtained is aerated under a high pressure of ca. 3 bar for a period of ca. 3 min. In a following mixing process, the fat mixture is added to the sugar/protein composition whipped by aeration and homogeneously distributed therein. Lastly, roasted peanuts are added as a flavor additive to the homogeneous fat/sugar/protein composition obtained. Here, it is important that the peanuts be folded in gently so as to not destroy the structure of the aerated fat/sugar/protein composition.

Step II: Forming of core bodies (centers) of the confectionery products from the base composition produced. For this processing, it is advantageous for the base composition to have a temperature in the range from 30-70° C. For this purpose, the base composition is, for example, shaped into rolls and continuously fed into a pair of rollers by means of which a sheet strand is formed. The sheet of the base composition has, for example, a thickness of 10 mm. The sheet of the base composition obtained is placed on a temperature-controllable conveyor belt and fed to a rolling mill, for example, a six-roll rolling mill, by means of which the sheet of the base composition is brought to the desired final thickness. Following this, a pair of embossing rollers is disposed, which, by means of depressions on the two rollers, for example, stamp nodules into the sheet of the base composition as core bodies. The diameter of the nodules is, for example, ca. 10 mm. It is understood that invention is not restricted to this, but rather that the core bodies can have any other suitable shape and size.

The sheet of the base composition then runs on a wire mesh band through a paternoster cooler and is cooled to ca. 10° C., with the cooling period lasting ca. 10 minutes. Through cooling, the consistency of the sheet of the base composition becomes more solid such that the pre-shaped nodules can be separated in a simple manner from the remaining sheet of the base composition.

After the nodules have been separated at ca. 10° C., they are fed to a deburring drum, in which they are freed of still adhering sheet residues and the edges are rounded. The nodules that are now completely round are presorted through a sieve arrangement to eliminate nodules that are not properly stamped, for example, half or double nodules, being sorted out for processing in the rest of the process. The remaining sheet of the base composition and rejected nodules can be fed back into the process for the forming of core bodies such that the core bodies can be produced virtually without base composition loss.

The nodular core bodies obtained in this manner have a diameter of ca. 10 mm and a weight of, for example, ca. 0.65 g. The structure of the core bodies can be very solid and can resemble hard caramel, with the surface not completely smooth due to the processed peanuts.

Step III: Subjecting the nodular core bodies to microwave vacuum drying (microwave puffing) in a drum-shaped microwave vacuum drying vessel under special conditions. Microwave puffing differs radically from other conventional drying methods that transfer the drying energy either through thermal convection or through contact with warm areas via the surfaces into the products to be dried, with the progress of the drying process determined by the thermal conductivity of the products from the outside to the inside. In contrast, the drying energy of the microwaves acts in the entire volume of the product to be dried such that it is not the thermal conductivity of the products that determines drying success but rather the capability of the products to convert the energy of the microwaves into heat. Since, as is well known, the energy of microwaves can be converted particularly well into heat by water, rapid vaporization of the moisture contained in the interior of the product is obtained by means of the microwave heating, whereby the drying process proceeds quickly and economically until the desired residual moisture is achieved. Aroma and taste can be largely retained and even intensified. On the other hand, the combination of microwave radiation and vacuum enables not only gentle drying of the products but also puffing (swelling), i.e., an increase in volume of the products, which can reach many times the initial volume.

As experiments of the applicant have demonstrated, the vacuum at the time of puffing has an effect on the core bodies, which is readily observable visually. When, for example, nodular core bodies with a diameter of ca. 10 mm are produced, the core bodies have, before microwave puffing, for example, a virtually smooth, glossy surface, with it being clearly discernible in cross-section that the core bodies are a homogeneous mass without air pockets (visual observation). Now, when the microwave puffing (with a vacuum) is carried out, the core bodies retain their nodular shape, with the diameter of the core bodies increasing and, for example, rising to ca. 15-20 mm. The color of the core bodies is brighter and the structure crispy and solid. The cross-section of the core bodies presents a clear porous appearance (visual observation), which is associated with the volume increase of the core bodies. The pores represent air pockets. When, in contrast, no vacuum is applied at the time of the microwave treatment, the core bodies lose their nodular shape, flow out, and obtain a flat shape. The size of the non-nodular core bodies is, along the longest dimension, ca. 15 mm, with a height of ca. 5-7 mm. The surface structure remains smooth and glossy. The consistency of the core bodies is soft and their color is dark. Moreover, the core bodies produced without a vacuum have no pores in cross-section, but are instead a compact mass without air pockets.

For the microwave puffing, the nodular core bodies are fed to the microwave vacuum drying vessel, for example, by a bucket conveyor, with the core bodies first filled into a hopper by means of which the microwave vacuum drying vessel is filled in batches. The drum-shaped microwave vacuum drying vessel has, for this purpose, for example, a flap opening that is up during filling and is disposed below the hopper. Advantageously, the fill height of the nodular core bodies in the drum-shaped microwave vacuum drying vessel is ca. 10 cm, since it has been demonstrated that with a greater fill height, the puffing result is unsatisfactory. Consequently, the microwave vacuum drying vessel should have a length suitable not to exceed the desired fill height with a given batch size.

At the time of the filling of the microwave vacuum drying vessel and during the performance of the microwave vacuum drying of the nodular core bodies, it is advantageous for the core bodies to have a temperature of ca. 12 to 14° C., by means of which sticking together of the core bodies can be reliably and safely avoided. Moreover, microwave puffing of the nodular core bodies below the temperature indicated is not optimal, with, in particular, the desired volume increase not being obtained.

During the microwave puffing, the drum-shaped microwave vacuum drying vessel mounted on rollers, for example, is rotated to the left and right around a cylinder axis, with the angle of inclination toward each side being, for example, ca. 90°. The speed at which the drum is rotated is very important for obtaining a good result. In the present embodiment, the speed was set to 5 m/min. In addition, deflectors, by means of which a constant movement of the nodular core bodies is supported, are installed in the microwave vacuum drying vessel. The shape of the deflectors can be important for the result obtained. If the deflectors are too small, there is the risk that the core bodies will stick together due to too little movement and rising temperature. On the other hand, if the deflectors are too large, the mechanical load on the core bodies is too high and the core bodies drop from too great a height, which again can result in sticking together. If agglomerations of nodular core bodies develop due to sticking together, it is virtually impossible to break them down without damage to the core bodies.

The drum is loaded in batches with nodular core bodies, with a vacuum of, for example, ca. 30 mbar set in a first phase (“puffing phase”). In the puffing phase, setting an appropriately low vacuum is important to give the nodular core bodies the final form and size as desired. If no adequately high vacuum is set during the puffing phase, there is the risk that the nodular core bodies will not reach the desired size and will instead assume an egg shape. After the desired vacuum is obtained, the irradiation of the core bodies with microwaves is started. The microwave power is progressively introduced into the core bodies. Care must be taken that the microwave energy not be too high at the onset since this can result in the fact that the core bodies dry too soon from the inside but are still too moist on the outside. As a result, the core bodies burn in their core. In the present exemplary embodiment, the core bodies are irradiated with microwaves with a power of 7 kW (kilowatts) for 90 s (seconds). Then, the power is raised to 9 kW and the core bodies are irradiated for 180 s. In a second phase (“drying phase”), the vacuum is set to 45 mbar. The nodular core bodies have now already reached their desired target size and lost ca. 3-4% water. At this vacuum level, microwave energy is introduced again, with the core bodies being irradiated with microwaves with the power of 6 kW for 270 s.

Here, it is important that the core bodies not exceed a temperature of ca. 80° C. during the introduction of microwave energy since, otherwise, burning in the core cannot be ruled out. Before the puffing, the nodular core bodies have a diameter of ca. 10 mm with a weight of ca. 0.65 g. After the puffing, the nodular core bodies have a diameter of ca. 18-20 mm with a weight of ca. 0.61 g. Accordingly, the drying loss amounts to ca. 5.9 wt.-%. The volume increase of the core bodies is associated with an extraction of moisture, with the taste properties of the core bodies being retained and even further intensified.

The nodular core bodies have, after puffing, a thin-walled shell, the surface is somewhat porous and not perfectly round, since the peanut pieces protrude partially. The interior of the nodular core bodies has a very different porous structure that consists of large and small non-uniform air pockets. Despite the thin-walled shells, the core bodies have, because of this texture, a crisp and cookie-like bite. The puffed nodular core bodies are strongly hygroscopic, with high relative humidity alone already sufficient to change the shape and taste of the core bodies. This necessitates the next step.

Step IV: Coating the puffed core bodies with chocolate such that a barrier layer is created by means of which a chemical exchange process during which the core body absorbs water is prevented, at least for the most part. As experiments have demonstrated, this measure can increase the shelf life of the confectionery product to the average shelf life of the chocolate used, which is usually 12 months. For coating by means of glazing, the puffed core bodies are, for example, fed into the glazing drum, for example, via a holding vessel. Advantageously, the confectionery product thus obtained has a ratio between the core body and the glazed chocolate mass of 25 wt.-% to 75 wt.-%. For example, the core bodies have in each case a piece weight of 0.6 g (25 wt.-%); the chocolate mass used per core body, a weight of 1.8 g (75 wt.-%); and the confectionery product obtained, a weight of 2.4 g (100 wt.-%). Advantageously, the bulk weight of the confectionery products is ca. 0.38 Kg/L. The chocolate used for glazing, in particular milk chocolate, advantageously has a total fat content of at least 32 wt.-%. During processing, it is advantageous for the chocolate to have a temperature in the range from 42-44° C. With regard to the rheological properties, it is advantageous for the chocolate to have a viscosity of 2-3 Pa and a yield point of 4-6 Pa·s. For the glazing, the the nodular bodies are sprayed, for example, by spray devices in the continuously rotating glazing drums. The core bodies are gradually glazed with chocolate, with each spraying procedure being interrupted, for example, for 30 min, and with a cooling phase introduced upon further rotation of the glazing drum. This procedure is repeated, for example, 3 to 4 times until the entire application quantity of chocolate has been applied to the core bodies.

Lastly, the core bodies glazed with chocolate are completely coated with a glossy or polish layer. The shining of the core bodies can be performed with various auxiliary means, with the glazed core bodies in the present exemplary embodiment first pretreated with an oil and then post-treated with shellac. By means of the layer of shellac, an additional protection against drying out or moisture absorption can be achieved, by means which the shelf life of the confectionery products is further improved. In addition, better separation and sliding action as well as a particularly aesthetically attractive appearance can be achieved. After the application of the glossy layer, the finished confectionery product is forwarded to a rest phase for ca. 12 hours at ca. 18-20° C. and can then be packed in final packaging. The resting phase serves for drying and cooling of the confectionery products. Also, the confectionery products can air out since the glossy layer can have a rather unpleasant odor.

The confectionery products are at least approx. nodularly shaped and consists of a puffed core body that is composed of a cooked, whipped sugar/protein/fat composition and specially processed peanuts, as well as an outer coating layer made of chocolate, for example, milk chocolate, which is finally covered with a glossy or polish layer. The finished confectionery product weighs ca. 2.4 g and has a diameter of ca. 20-22 mm. The pre-processed peanuts give the finished confectionery product a very intensive peanut flavor that is further intensified by the microwave puffing since the moisture escapes from the core bodies and the aroma is increased even more by this. The crispness of the confectionery product is improved by the roasted peanuts since not only the texture of the puffed core bodies has a good bite but so do the peanuts. The overall taste of the confectionery product is very harmoniously tuned, with the intensive peanut note effected by the microwave puffing and the chocolate yielding a very well-rounded flavor profile.

1. A method for producing confectionery products, which comprises the following successive steps:
production of a base composition of a sugar component with one or a plurality of sugar-containing constituents, wherein the sugar content of at least one sugar-containing constituent is more than 50 wt.-%, a protein component with one or a plurality of protein-containing constituents, wherein the protein content of at least one protein-containing constituent is more than 50 wt.-%, a fat component with one or a plurality of fat-containing constituents, wherein the fat content of at least one fat-containing constituent is more than 60 wt.-%, and a flavor additive with at least one flavoring constituent;
forming of core bodies from the base composition;
microwave vacuum drying of the core bodies;
coating of the core bodies with at least one coating layer, in particular chocolate, which is suitable for inhibiting absorption of moisture by the core bodies.

2. The method of claim 1, wherein the core bodies are coated with a first coating layer, in particular chocolate, and with a second coating layer over the first coating layer, in particular are glazed with shellac.

3. The method of claim 1, wherein the production of the base composition comprises the following successive steps:
heating the sugar component;
cooling the sugar component;
adding the protein component to the sugar component to produce a sugar/protein composition;
aerating the sugar/protein composition;
adding the fat component to the sugar/protein composition and its homogeneous distribution therein to produce a fat/sugar/protein composition; and
adding a flavor additive to the sugar component and/or to the fat component and/or to the protein component and/or to the sugar/protein composition and/or to the fat/sugar/protein composition.

4. The method of claim 3, wherein the sugar component is heated in a temperature range from 120-130° C., in particular at 125° C., in particular with a dry composition of 92 wt.-%.

5. The method of claim 3, wherein the sugar component is cooled to a temperature of ca. 110° C., for example, for example, by evacuation.

6. The method of claim 3, wherein the sugar/protein composition is aerated under a high pressure of, in particular, 3 bar, in particular for a period of 3 min.

7. The method of claim 1, wherein the forming of the core bodies from the base composition comprises the following successive steps:
forming a sheet of the base composition;
stamping in particular nodular core bodies into the sheet of the base composition;
separating the core bodies from the remaining sheet of the base composition;
selecting the core bodies based on a predefinable core body size.

8. The method of claim 7, wherein the core bodies are stamped into the sheet of the base composition in a temperature range from 30-70° C.

9. The method of claim 7, wherein the core bodies are separated from the remaining sheet of the base composition at a temperature of the sheet of the base composition in a range from 8-12° C., in particular at 10° C.

10. The method of claim 1, wherein the core bodies have, during microwave vacuum drying, a maximum fill height in a range from 8-12 cm, in particular 10 cm, in a microwave vacuum drying vessel haben.

11. The method of claim 1, wherein the microwave vacuum drying of the core bodies comprises the following successive steps:
a) creating a vacuum, in particular of 30 mbar, with simultaneous movement of the core bodies, with a microwave vacuum drying vessel being moved, in particular at a speed of 5 m/min;
b) successive irradiation of the core bodies with microwave radiation at the vacuum established in step a) in accordance with the following procedure:
irradiation of the core bodies with a microwave radiation power in the range from 6-8 kW, in particular at 7 kW, for a period in the range from 80-100 s, in particular 90 s;
irradiation of the core bodies with a microwave radiation power in the range from 8-10 kW, in particular at 9 kW, for a period in the range from 170-190 s, in particular 180 s;
c) creating a vacuum, in particular of 45 mbar;
d) irradiation of the core bodies at the vacuum established in step c) with a microwave radiation power in the range from 5-7 kW, in particular at 6 kW, for a period in the range from 260-280 s, in particular 270 s.

12. The method of claim 11, wherein the microwave radiation power is selected such that the core bodies have a maximum temperature in the range from 75-80° C., in particular 80° C.

13. The method of claim 12, wherein the core bodies are in each case coated with the at least one coating layer such that the core body has a weight share, based on the coated core body, in the range from 24-26 wt.-%, in particular 25 wt.-%.

14. A confectionery product, comprising:
a core body puffed by microwave vacuum drying, which is produced from a base composition, containing a sugar component with one or a plurality of sugar-containing constituents, wherein the sugar content of at least one sugar-containing constituent is more than 50 wt.-%, a protein component with one or a plurality of protein-containing constituents, wherein the protein content of at least one protein-containing constituent is more than 50 wt.-%, a fat component with one or a plurality of fat-containing constituents, wherein the fat content of at least one fat-containing constituent is more than 60 wt.-%, and a flavor additive with at least one flavoring constituent; arid
at least one coating layer, in particular chocolate, coating the core body, which coating layer is suitable for inhibiting absorption of moisture by the core bodies.

15. The confectionery product of 14, wherein the core body is coated with a first coating layer, in particular chocolate, and with a second coating layer over the first coating layer, in particular, is glazed with shellac.
